(19) United States
(12) Patent Application Publication
(10) Pub. No.: US 2012/0133157 A1
(43) Pub. Date: May 31, 2012

(54) DOOR LOCKING ARRANGEMENT AND WORK MACHINE COMPRISING A DOOR LOCKING ARRANGEMENT

(75) Inventors: Oliver Bichler, Pluwig (DE); Alfred Richter, Eisenach (DE)

(73) Assignee: VOLVO CONSTRUCTION EQUIPMENT AB, Eskilstuna (SE)

(21) Appl. No.: 13/388,479

(22) PCT Filed: Aug. 13, 2009
(86) PCT No.: PCT/SE09/00378

§ 371 Date: Feb. 2, 2012

(51) Int. Cl. E05C 17/56; E05C 19/10; E05C 17/00

(52) U.S. Cl. 292/95; 292/2

(57) ABSTRACT

A door locking arrangement is provided for a door of a work machine for holding the door in an open position, wherein the door is pivotably connected to a cab wall. The door locking arrangement includes a first holding element and a second holding element forming a releasable connection for holding the door in its open position, wherein one of the two holding elements is arranged at an outside of the door facing the cab wall when the door is in its open position and the other holding element is arranged at the cab wall. An electric actuator is provided for releasing the releasable connection by separating the first holding element from the second holding element when the door is to be moved from its open position to its closed position.

### BACKGROUND AND SUMMARY

The invention relates to a door locking arrangement for a work machine for holding the door in an open position, wherein the door is pivotably connected to a cab wall, and to a work machine comprising a door locking arrangement.

It is known in the art that work machines, such as stationary or mobile construction equipment like earthmoving machines, rough terrain lift trucks, mobile cranes and other machines operated outdoors normally include a cabin (“cab”) or an enclosure for an operator of the machine. The cab typically includes one or more doors that when closed protect the cab during inclement weather. In certain situations, however, the operator is desirous of being able to maintain the door open when operating the machine. As a result, it is customary to provide some kind of self-latching hold-open restraint to catch and hold the door as it is swung towards its open position. For closing the door, the operator pulls the door towards its closed position.

U.S. Pat. No. 4,335,911 A1 discloses an electromagnetic locking arrangement were a locking rod is pivotable about a horizontal axis from a resting position pointing vertically downward to a horizontal position in which the locking rod locks the door in its open position. When the door is locked with the locking rod, the locking rod extends in the clearance between the cab wall and the door. The locking rod engages with its soft magnetic tip an electromagnet of an electromagnetic locking arrangement. When the operator wants to close the door a current flow to the electromagnetic locking arrangement is stopped and the locking rod disconnects from the door. As a result the locking rod falls back into its vertical resting position and the door can be closed. While the door is in its open position, the locking rod spans across the clearance between the cab wall and the door.

It is desirable to provide a door locking arrangement for a work machine for holding the door in an open position which provides free access to the cab and can be operated in a comfortable way.

It is also desirable to provide a work machine comprising a door locking arrangement.

According to a first aspect of the invention a door locking arrangement for a door of a work machine is proposed for holding the door in an open position, wherein the door is pivotably connected to a cab wall. The door locking arrangement comprises a first holding element and a second holding element forming a releasable connection for holding the door in its open position. One of the two holding elements is arranged at an outside of the door facing the cab wall when the door is in its open position, and the other holding element is arranged at the cab wall. An electric actuator is provided for releasing the releasable connection by separating the first holding element from the second holding element when the door is to be moved from its open position to its closed position.

Favourably, the operator can close the door of the cab without manually handling the door, e.g. by leaving the operator seat or the cab or leaning out of the cab in order to reach the door handle. A manual adjustment of the door for separating the connection between the first and second holding elements can be avoided. The electric actuator can move the first holding element and/or the second holding element into the right position for releasing the door.

Particularly, the first holding element and second holding element can form the releasable connection when the door is swung open by more than 90°.

Advantageously, by opening the door for instance by substantially 180° the first holding element is automatically in operative connection to the second holding element (or vice versa) in the end position of the open door. The first and second holding elements can be arranged at the same height for ensuring a safe connection.

Generally, the electric actuator can be arranged in a way which best suits the actual ambient of the cab. For instance, the electric actuator can be connected to the cab wall. The actuator can be arranged in a section of the cab which is stationary which facilitates the wiring and the mechanical components of the actuator. Alternatively, the electric actuator can be connected to the door.

According to a favourable embodiment of the invention, the releasable connection can be formed by a one of the holding elements engaging the other holding element. This allows for a reliable locking of the door in its open position.

As an advantageous example of such an engaging solution, the first holding element and the second holding element can form a snap-fit connection.

Expediently, the door can be positioned in a stable and reliable connection.

Preferably, the snap-fit connection can comprise a hook and an eye. Alternatively or additionally, the snap-fit connection can comprise a notch and a catching recess. The connection can be established in a reliable way with a comfortable tolerance for the first and second holding elements.

According to another favourable embodiment of the invention, the electric actuator can comprise an electric motor for moving at least one of the first and the second holding elements. Favourably, a movement for releasing the connection between the first holding element and the second holding element can be performed with high accuracy.

According to another favourable embodiment of the invention, the electric actuator can comprise a servo motor for moving at least one of the first and the second holding elements. Favourably, the first and/or the second holding element can be sensibly and reproducibly moved for disengaging the connection in between.

According to another favourable embodiment of the invention, the electric actuator can constitute one of the first and second holding elements. A space economic and robust installation is possible without additional components for the actuator.

According to another favourable embodiment of the invention, the first holding element and the second holding element can form an electromagnetic connection. Particularly, the electric actuator can comprise an electromagnet device.

Releasing the connection between the first and second holding element is in this case very easy to achieve by simply switching off a current to the electromagnet.

According to another favourable embodiment of the invention, the electric actuator can be adapted to be operable by a switching element arranged in the cab.

Preferably, the switching element is arranged in such a way that it can be easily reached and operated by the operator while sitting on the seat. The switching element can be a simple push button, a joystick, a slider or the like. The comfort for the operator is improved; the door can be easily closed by disengaging the locking arrangement.

According to another aspect of the invention, a work machine is proposed comprising a door locking arrangement according to any feature described above. The operation comfort of the vehicle and the operation safety is improved as the operator can avoid releasing the door locking arrangement manually.

### BRIEF DESCRIPTION OF THE DRAWINGS

The present invention may best be understood from the following detailed description of the embodiment, but not restricted to the embodiments, wherein is shown schematically:

FIG. 1 a perspective view of a detail of a cab door with an advantageous example embodiment of a door locking arrangement according to the invention;

FIG. 2 a perspective view of the door locking arrangement of FIG. 1 from the inside of the cab without cover;

FIG. 3 a detailed view of a section of the door locking arrangement of FIG. 2; and

FIG. 4 an excavator as an example embodiment of a work machine equipped with a preferred door locking arrangement according to the invention.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

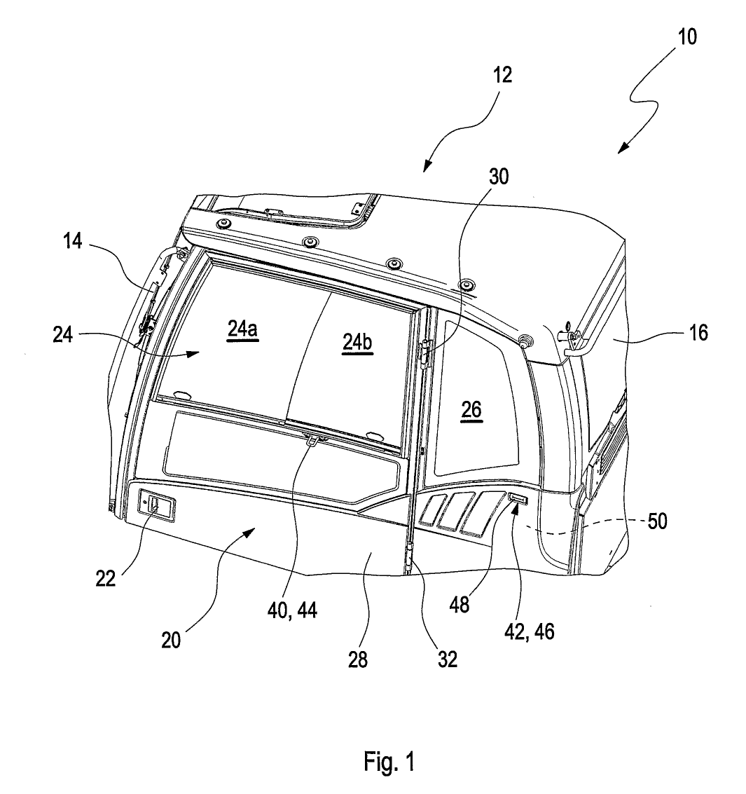

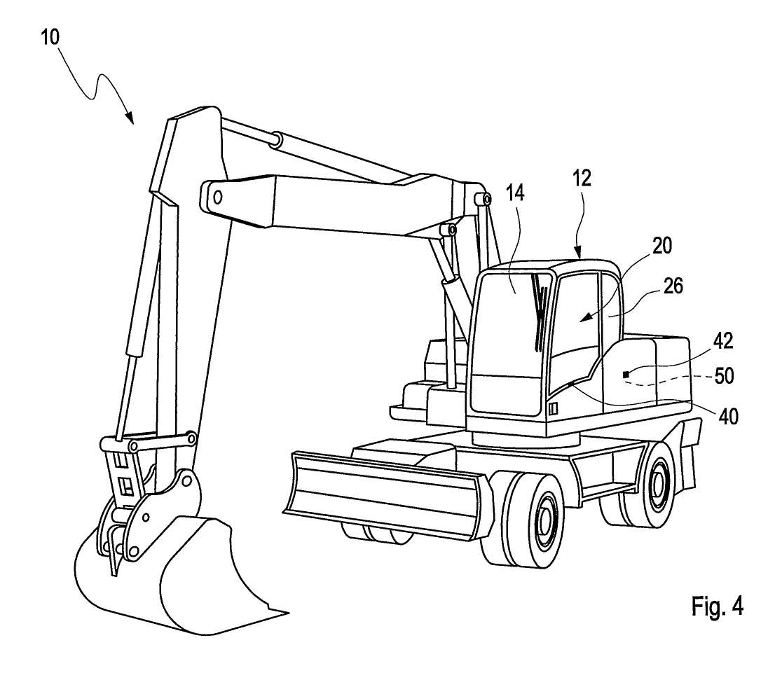

FIG. 1 depicts a perspective view of a detail of a cab 12 of a work machine 10 (FIG. 4) with an example embodiment of a door locking arrangement according to the invention.

A door 20 is attached to the cab 12 via hinges 30, 32 at a cab wall 26 and pivotable between a first, closed position and a second, fully open position. The door 20 has typically a door handle 22 for manually opening, closing and locking the door 20 and a window 24 which may comprise one or two sliding panes 24a and 24b. The cab has a front side 14 and a rear side 16.

A door locking arrangement for holding the door 20 in its open position comprises a first holding element 40 arranged at the door 20 and a corresponding second holding element 42 arranged at a cab wall 26. The first and the second holding elements 40, 42 form a releasable connection when the door 20 is in its open position. The first holding element 40 automatically locks with the second holding element 42 when the door 20 is swung open by about 180° when the outside 28 of the door 20 comes close to the cab wall 26. In the present example embodiment, the releasable connection is realized in form of a snap-fit connection comprising as first holding element 40 a notch 44 arranged at the outside 28 of the door 20 and as second holding element 42 a catching recess 46 arranged at the outside of the cab wall 26. When the door 20 is swung open by about 180°, the notch 44 engages the catching recess 46 and is locked. Of course, the positions of the notch 44 and the recess 46 can be exchanged, i.e. the notch 44 can be arranged at the cab wall 26 and the catching recess 46 can be arranged at the door 20.

In the present example embodiment the catching recess 46 has a self adjusting guiding area 48 so that the notch 44 is securely introduced into the mouth of the catching recess 46.

For separating the releasable connection between the first and the second holding element 40, 42 an electric actuator 50 is provided. Releasing the releasable connection is achieved by separating the first holding element 40 from the second holding element 42 with the help of the electric actuator 50. As a result of this separation, the door 20 can be moved from its open position to its closed position. Typically, the door 20 can be biased so as to fall automatically into the closed position when released from the connection.

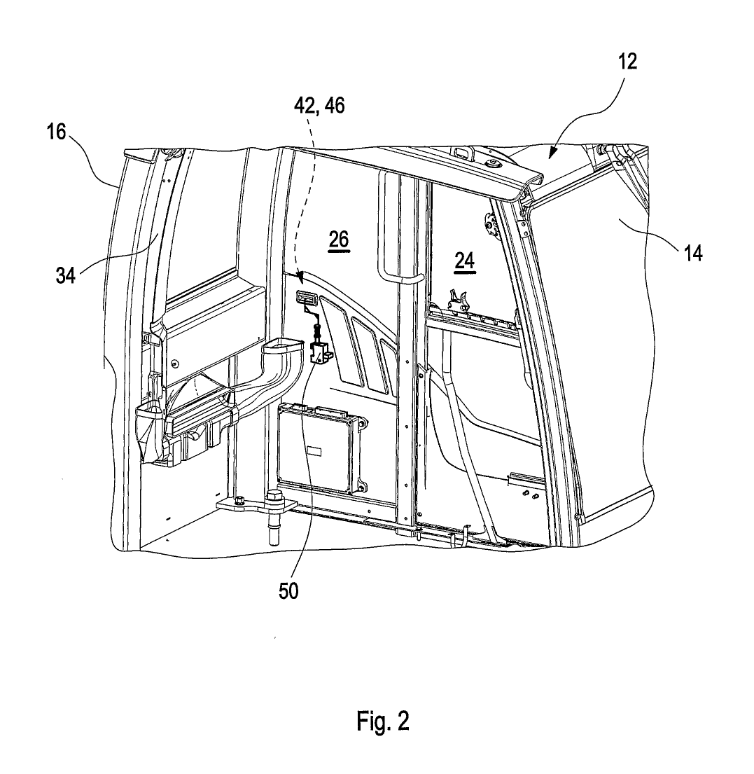

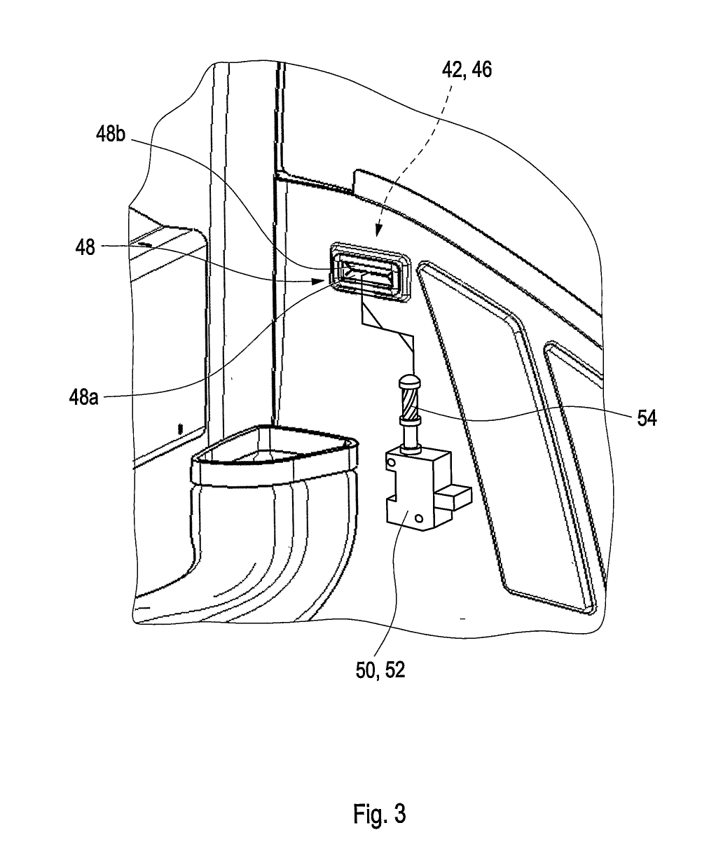

FIG. 2 illustrates a perspective view of the door locking arrangement of FIG. 1 in the cab wall 26 without cover from the inside of the cab 12 seen from a door opening 34 opposite of the door 20 (with window 24) that is in its closed position. The cab 12 in FIG. 2 is turned by 180° compared with the cab 12 shown in FIG. 1, the cab 12 of FIG. 2 having its front side 14 on the right hand side of the Figure and its rear side 16 on the left hand of the Figure. The electric actuator 50 is mounted on the inside of cab wall 26 and is operatively connected with the second holding element 42, i.e. the recess 46. The part of the cab wall 26 with the electric actuator 50 and the recess 46 are shown in more detail in FIG. 3 which is an enlarged view of that portion of FIG. 2.

Referring now to FIG. 3, the electric actuator 50 may comprise an electric motor 52 for moving at least one of the first and the second holding elements 40, 42 so as to disengage it from the respective other holding element 40, 42, thereby releasing the releasable connection between the first and the second holding element 40, 42. For instance, the electric actuator 50 can drive a gear 54 which opens guiding elements 48a, 48b of the guiding area 48 of the catching recess 46 forming the second holding element 42 in the present example by e.g. moving them (i.e. one or both guiding elements 48a, 48b) apart from each another.

In a second embodiment which is not illustrated, the first holding element 40 and the second holding element 42 form an electromagnetic connection and the electric actuator 50 can comprise an electromagnetic device. For instance, the first holding element 40 can be a magnetically soft plate and the second holding element 42 can be a coil which, when supplied with an electric current, produces a magnetic field. The magnetic plate will stick to the second holding element 42 while the electric current flows through the coil.

FIG. 4 shows an excavator as an example embodiment of a work machine 10 equipped with a door locking arrangement according to the invention. An operator can swing the door 20 open into its open position where it is automatically locked by the door locking arrangement 40, 42, 50 and comfortably release the door 20 from the locked state in the door's fully open position by way of the described door locking arrangement. The door locking arrangement comprises a first holding element 40 and a second holding element 42 forming a releasable connection when the door 20 is in its fully open position. The operator can press a switch (not shown) in the cab 12, that is arranged at a suitable place, e.g. on the dashboard or at the door or at any convenient location, wherein the switch activates an electric actuator 50 which opens the releasable connection between the first and the second holding element 40, 42.

1. A door locking arrangement for a door of a work machine for holding the door in an open position, wherein the door is pivotably connected to a cab wall, comprising
(i) a first holding element and a second holding element forming a releasable connection for holding the door in its open position, wherein one of the two holding elements is arranged at an outside of the door facing the cab wall when the door is in its open position and the other holding element is arranged at the cab wall, and
(ii) an electric actuator for releasing the releasable connection by separating the first holding element from the second holding element when the door is to be moved from its open position to its closed position.

2. The door locking arrangement according to claim 1, wherein the electric actuator is connected to the cab wall and/or to the door.

3. The door locking arrangement according to claim 1, wherein the releasable connection is formed by a one of the holding elements engaging the other holding element.

4. The door locking arrangement according to claim 1, wherein the first holding element and the second holding element form a snap-fit connection, preferably in form of a hook and an eye or in form of a notch and a catching recess.

5. The door locking arrangement according to claim 1, wherein the electric actuator comprises an electric motor, in particular a servo motor for moving at least one of the first and second holding elements.

6. The door locking arrangement according to claim 1, wherein the electric actuator constitutes one of the first and second holding elements, and preferably that the electric actuator comprises an electromagnet.

7. The door locking arrangement according to any preceding claim, wherein the first holding element and the second holding ele claim 1 ment form an electromagnetic connection.

8. The door locking arrangement according to claim 1, wherein the electric actuator is adapted to be operable by a switching element arranged in the cab.

9. A work machine comprising a door locking arrangement according to claim 1.
